(19) United States
(12) Patent Application Publication
(10) Pub. No.: US 2011/0300635 A1
(43) Pub. Date: Dec. 8, 2011

(54) CHEMICAL INDICATOR TEST STRIP

(75) Inventor: Vinod P. Menon, Woodbury, MN (US)

(73) Assignee: 3M Innovative Properties Compnay

(21) Appl. No.: 13/210,531

(22) Filed: Aug. 16, 2011

Related U.S. Application Data
(62) Division of application No. 11/611,926, filed on Dec. 18, 2006.

(51) Int. Cl. G01N 21/78

(52) U.S. Cl. 436/93; 436/169; 436/131; 436/130; 436/129; 436/120

(57) ABSTRACT

Articles and methods for the detection and/or quantification of organic analytes are described. The invention provides a chemical indicator test strip, comprising: a substrate; and a coating comprising a leuco dye complex on the substrate, the coating being insoluble in water and reactive with an organic analyte, the coating derived from a solution of leuco dye and developing agent. In another aspect, the coating further comprises adjuvant, in the form of a water-insoluble, polar, hydrophobic, aprotic material that extends the lower limit of detection for the analyte. In still another aspect, the present invention provides a method of using a chemical indicator test strip, comprising: (a) exposing the chemical indicator test strip to a sample comprising an organic analyte; (b) measuring a color change on the chemical indicator test strip following the exposing step; and (c) correlating the color change with the concentration of the analyte in the sample.

### CROSS REFERENCE TO RELATED APPLICATIONS

This application is a division of U.S. patent application Ser. No. 11/611,926, filed Dec. 18, 2006, which is incorporated herein by reference.

The present invention relates to chemical indicator test strips and to methods for the use of chemical indicator test strips for the detection and quantification of organic analytes.

### BACKGROUND

It is desirable to detect and monitor certain organic compounds in various industrial or commercial processes. For example, the detection of solvents in certain process streams is important in a number of industrial processes such as processes in the semi-conductor industry, processes for fermentation and distillation, as well as processes for the extraction and preparation of vitamins, alkaloids, and antibiotics. Additionally, organic contamination from hazardous waste sites and underground storage tanks can threaten the quality of groundwater, necessitating an effort to sample and analyze an ever-increasing number of monitoring wells.

Current monitoring technology includes the use of gas chromatography and typically requires a long delay between sample collection and the communication of analytical results. More generally, known monitoring technology typically utilizes expensive, labor-intensive, discrete methods that can introduce uncertainties in sampling and handling procedures. The inability of conventional methods to provide in-situ real-time monitoring for organic analytes is an unmet need in the industry.

Lactones derived from substituted 3,3′-diphenylphthalides yield a triphenylcarbenium ion by interaction with a weak acid component such as bisphenol A. This color-producing reaction has found use in microcapsule coating technology used in carbonless pressure-sensitive copy paper and thermochromic print paper. Posch and Wolbeis (Talanta, Vol. 35, No. 2, pp. 89-94, 1988) have demonstrated the use of thermal paper as a colorimetric indicator for polar solvent vapor in air. In this article, fully developed intensely colored thermal paper shows a decrease in color intensity on exposure to the vapor. The decrease in intensity is proportional to the partial pressure of the vapor and is attributed to the disturbance of the hydrogen bonded network by the solvent vapors converting the colored quinoid dye to the colorless lactone form. Dickert and coworkers (Anal. Chem. 1988, 60, 1377-1380) have spin-coated a mixture of the lactone dye and proton donor on quartz plates in conjunction with a transmissive optical detection system to serve as an optochemical sensor for low-boiling polar solvent vapors. Because the foregoing techniques have been limited to the detection of a solvent in vapor form, they have failed to provide for the monitoring of organic compounds in a liquid water stream. Additionally, these techniques have typically required expensive optics and calibration systems, and such techniques are known to be sensitive to both temperature and humidity.

Test strips or indicator sticks are available to indicate the presence and concentration of an analyte in a liquid by immersing the strip or indicator stick into the liquid and observing the color change and color intensity. These products include the familiar litmus test for pH measurement as well as sophisticated tests for detecting clinically significant markers in biological fluids such as glucose or protein in blood and urine samples. Test strips or indicator sticks represent inexpensive single-use analytical tools that embody a high level of accuracy and can be used qualitatively with a visual comparator chart or in conjunction with a readout device for quantitative information and electronic record keeping.

It is desirable to provide a test strip or indicator stick that is immersible in water and that is useful in the quantitative measurement and monitoring of water-miscible organic compounds.

### SUMMARY

The invention provides articles and methods for the detection and/or quantification of organic analytes. In one aspect, the invention provides a chemical indicator test strip, comprising:
A substrate; and
A coating comprising a leuco dye complex on the substrate, the coating being insoluble in water and reactive with an organic analyte, the coating derived from a solution of leuco dye and developing agent.

In general, the terms used herein will be understood to have a meaning consistent with the meaning given by those of ordinary skill in the art. For clarity, certain terms are further defined herein.

As used herein, “leuco dye” refers to a dye whose molecules can acquire two forms, one of which is colorless.

“Leuco dye complex” refers to a complex comprised of one or more leuco dyes combined with one or more developing agents.

“MIBK” is an abbreviation for methyl isobutyl ketone.

“PSA” is an abbreviation for pressure-sensitive adhesive.

In another aspect, the invention provides the foregoing chemical indicator test strip wherein the coating further comprises adjuvant, wherein the adjuvant is a water-insoluble, polar, hydrophobic, aprotic material that extends the lower limit of detection for the analyte than is otherwise attainable in the absence of such an adjuvant.

In still another aspect, the present invention provides a method of using a chemical indicator test strip, comprising:

(a) Exposing a chemical indicator test strip to a liquid sample comprising an organic analyte in solution, the chemical indicator test strip, comprising:
A substrate; and
A coating comprising a leuco dye complex on the substrate, the coating being insoluble in water and reactive with an organic analyte, the coating derived from a solution of leuco dye and developing agent;

(b) Measuring a color change on the chemical indicator test strip following the exposing step;

(c) Correlating the color change with the concentration of the analyte in the sample.

Features of the present invention will be more fully appreciated by those skilled in the art upon consideration of the remainder of the disclosure including the Detailed Description of the Embodiments taken together with the various Examples and the Figures as well as the appended claims.

### BRIEF DESCRIPTION OF THE DRAWINGS

In the description of the embodiments of the invention, reference is made to the various Figures, wherein:

FIG. 1 is a plot of optical density v. concentration of n-propanol using chemical indicator test strips described in Example 1 herein;

FIG. 2 illustrates plots of optical density v. concentration of (1) acetone and (2) propylene carbonate using chemical indicator test strips described in Example 3 herein;

FIG. 3 is a plot of optical density v. concentration of n-propanol using chemical indicator test strips described in Example 4 herein;

FIG. 4 is a plot of optical density v. concentration of n-propanol using chemical indicator test strips described in Example 5 herein;

FIG. 5 is a plot of optical density v. time for chemical indicator test strips described in Example 6 herein using three different developing agents;

FIG. 6 is a plot of optical density v. concentration of (1) propylene glycol and (2) n-propanol using chemical indicator test strips described in Example 7 herein;

FIG. 7 is a plot of optical density v. concentration of n-propanol using chemical indicator test strips described in Example 9 herein;

FIG. 8 is a plot of optical density v. concentration of n-propanol using chemical indicator test strips of Example 9 herein;

FIG. 9 is a plot of optical density v. concentration of n-propanol for chemical indicator test strips of Example 10 herein;

FIG. 10 is a plot of optical density v. concentration of propylene carbonate using chemical indicator test strips of Example 11 herein;

FIG. 11 is a plot of optical density v. concentration for chemical indicator test strips of Example 13 herein; and

FIG. 12 is a plot of optical density v. concentration for chemical indicator test strips of Example 15 herein.

### DETAILED DESCRIPTION OF THE EMBODIMENTS

Embodiments of the present invention are described herein. The invention provides a chemical indicator test strip and methods for the use of a chemical indicator test strip for the qualitative and quantitative monitoring of organic compounds. Embodiments of the invention provide a colorimetric, immersible, chemical indicator test strip that can be used to rapidly and quantitatively determine the concentration of organic compounds in water or other solvents. As used herein, “chemical indicator test strips” and “test strips” are used interchangeably in reference to the articles of the present invention.

The inventive test strips comprise a substrate coated with a leuco dye complex capable of withstanding immersion in the solvent and particularly in aqueous systems. In embodiments of the invention, the leuco dye complex is originally provided in a liquid indicator composition comprised of a leuco dye, a developing agent and optional additional components that enhance the performance of the test strip. In some embodiments, optional additional components are added to enhance the ability of the finished chemical indicator test strip to detect a particular analyte and/or to improve the sensitivity of the test strip at lower analyte concentrations. The liquid indicator composition is coated onto the substrate and dried to provide a chemical indicator test strip according to the present invention.

Leuco dye complexes comprise at least one color-forming agent and at least one developing agent which, when combined, impart a non-white or colored appearance to the surface of the substrate of the chemical indicator test strip. However, the leuco dye complex reverts or “bleaches” to an uncolored state in the presence of an organic analyte that is capable of solvating the develop agent. The extent of the color change or bleaching is proportional to the concentration of the analyte in water so that, as the concentration of the organic analyte increases, the chemical indicator test strip becomes progressively lighter in color. With prior standardization, the degree to which the test strip changes color can be correlated with the concentration of the analyte.

### Leuco Dye

The leuco dye complex useful in the chemical indicator test strips of the present invention comprise a color-forming agent and a developing agent. In embodiments of the invention, suitable classes of leuco dyes include fluorans, rhodamines, and triarylmethane lactone leuco dyes. These compounds react with acidic developing agents, such as Lewis acids, salicylic acids, phenolic compounds, or acidic clays, to form highly colored species by the opening of a lactone ring. Specific examples of such compounds include without limitation those known under the trade name “PERGASCRIPT” (Ciba Specialty Chemicals of Tarrytown, New York). Another leuco dye useful in embodiments of the invention is the leuco dye crystal violet lactone (a triarylmethane lactone). In its lactone form, crystal violet lactone is colorless or slightly yellow. But, in a low pH environment, it becomes protonated and exhibits an intensely violet color.

The following non-limiting listing of leuco dyes are suitable for use herein, either individually or in combinations of two or more:
acyl auramines
acylleucophenothiazines
alpha-unsaturated aryl ketones
azaphthalides
benzoyl leuco methylene blue
benzoyl leuco oxazine
benzoyl leuco thiazine
beta-unsaturated aryl ketones
basic mono azo dyes
bisindolylphthalide
10-benzoyl-N,N,N,N-tetraethyl-3,7-diamino-10H-phenoxazine
carbazolyl blue
chromogenic azaphthalide compounds
crystal violet lactone
diaryl phthalides
diphenylmethanes
dithio-oxamide
di[bis-(indoyl)ethyleneyl]tetraholophthalides
fluoran
fluoran derivatives (e.g., 3-dialkylamino-7-dialkylamylfluoran)
green lactone
3-(indol-3-yl)-3-(4-substituted aminophenyl)phthalides
indolyl bis-(indoyl)ethylenes
indolyl red
leucoauramines
leucobenzoyl methylene blue
leuco malachite green
3-methyl-2,2-spirobi(benzo-[f]-chromene)
phenoxazine
phthalide leuco dyes
phthlans
polystyrl carbinols and 8-methoxybenzoindolinospiropyrans
rhodamine beta lactams
spiropyrans
substituted 4,7-diazaphthalides
sultines
para-toluene sulfonate of Michler's hydrol
triarylmethane
triphenylmethanes (gentian violet and malachite green)
3,3-diaryl-3H-2,1-benzoxathiole 1-oxides

### Developing Agent

Developing agents are included in the leuco dye complexes of the invention. Such developing agents are often referred to as electron acceptors but are more accurately described as proton donors. In certain embodiments, the developing agent is water insoluble. In some embodiments, the developing agent is a weak acid selected from, octyl p-hydroxybenzoate, methyl p-hydroxybenzoate, 1,2,3-triazoles, 4-hydroxycoumarin derivatives, and combinations of two or more of the foregoing.

In some embodiments, Lewis acids may be used as developing agents in the leuco dye complexes discussed herein. Examples of such developing agents include activated clay substances, such as attapulgite, acid clay, bentonite, montmorillonite, acid-activated bentonite or montmorillonite, zeolite, hoalloysite, silicon dioxide, aluminum oxide, aluminum sulfate, aluminum phosphate, hydrated zirconium dioxide, zinc chloride, zinc nitrate, activated kaolin or other clay.

In other embodiments, acidic, organic compounds are useful as developing agents. Examples of such developing agents include ring-substituted phenols, resorcinols, salicylic acids (e.g., 3,5-bis(α,α′-dimethylbenzyl)salicylic; 3,5-bis((γ-methylbenzyl)salicylic acid), or salicyl acid esters and metal salts thereof (e.g., zinc salts). Additional acidic, organic compounds include certain polymeric materials such as, for example, a phenolic polymer, an alkylphenolacetylene resin, a maleic acid/colophonium resin or a partially or fully hydrolyzed polymer of maleic anhydride with styrene, ethylene or vinyl methyl ether, or carboxymethylene. Mixtures of two or more of the monomeric and polymeric acidic, organic compounds may also be used.

In still other embodiments, developing agents may be selected from phenolic resins or phenolic compounds such as 4-tert-butylphenol; 4-phenylphenol; methylene-bis (p-phenylphenol); 4-hydroxydiphenyl ether; alpha-naphthol; beta-napthol; methyl 4-hydroxybenzoate; benzyl 4-hydroxybenzoate; 4-hydroxydiphenyl sulfone; 4-hydroxyacetophenone; 2,2′-dihydroxydiphenyl; 4,4′-cyclohexylidenephenol; 4,4′-isopropylidenediphenol; 4,4-isopropylidenebis(2-methylphenol); a pyridine complex of zinc thiocyanate; 4,4-bis(4-hydroxyphenyl)valeric acid; hydroquinone; pyrogallol; phoroglucine; p-hydroxybenzoic acid; m-hydroxybenzoic acid; o-hydroxybenzoic acid; gallic acid; 1-hydroxy-2-naphthoic acid.

In still other embodiments, the developing agent is poly(4-vinyl phenol). In other embodiments the developing agent is 4,4′-(9-fluorenylidene)-diphenol.

### Adjuvant

In some embodiments of the invention, the leuco dye complex is optionally formulated with at least one adjuvant in the form of a water-insoluble, polar, hydrophobic, aprotic component. As used in the context of describing the adjuvant, “polar” refers to the ability of the material to form hydrogen bonds. In some embodiments, the polar, hydrophobic, aprotic adjuvant has a low vapor pressure (e.g., 0.1 mm Hg).

An adjuvant, when present, is added to an initial liquid indicator composition along with the leuco dye complex. The liquid indicator composition may then be applied to a substrate and dried to provide a chemical indicator test strip with an improved analytical range. In other words, the presence of an adjuvant improves the sensitivity of the chemical indicator test strip at lower analyte concentrations, extending the lower limits of detectability for a particular organic analyte. Inclusion of an adjuvant in the chemical indicator test strips of the invention is most typically desired where the detection of a particular analyte at lower concentrations is desired because the detection limit for an organic analyte is much lower in the presence of an adjuvant than would otherwise be achievable in the absence of such an adjuvant. In some embodiments, the inclusion of an adjuvant can extend the analytical range down to about 0.2% by weight of analyte in water.

The adjuvant compound typically is selected from compounds that will not confer color to the leuco dye. Representative and suitable compounds from this class include aliphatic esters and aromatic esters of carboxylic acids such as those selected from citrates, phthalates, adipates, benzoates, azelates, and mellitates. In some embodiments, the adjuvant is selected from organic phosphates, organic sulfonates, and sulfonamides. In other embodiments, adjuvants with a large number (e.g., greater than three) of polar functionalities per molecule are preferred. In still other embodiments, the adjuvant is selected from citrates and sulfonamides.

### Surfactants

In various embodiments of the invention, the chemical indicator test strip of the invention comprises a coating having a leuco dye complex associated with surfactant. In these embodiments, one or more surfactant is included in an initial liquid indicator composition applied to a substrate. Once dried, the resulting coating comprises the leuco dye complex and surfactant. One or more surfactants may be included with the dye complex in order to facilitate wetting of the substrate in an aqueous environment and as an aid in the transport of an organic analyte into the chemical indicator test strip and in association with the leuco dye complex thereon. Suitable surfactants may be selected from compounds that will not confer color in association with the leuco dye.

As is further explained below, surfactant may be included in a coatable liquid indicator composition with a leuco dye complex to be coated onto a substrate. The inclusion of surfactant may be desired for certain organic analytes. For example, the detection, monitoring and/or quantification of antimicrobial fatty acid monoesters in water is enhanced by the presence of surfactant in the chemical indicator test strips of the invention. Such antimicrobials may, for example, be used in the antimicrobial treatment of food items to prevent contamination by pathogens. In commercial applications, the fatty acid monoesters may be provided to a user in the form of a concentrated composition comprising, for example, between about 1.0-50.0 wt. % of the monoester. Prior to the application of the monoester to food, however, the concentrate can be diluted with water to provide a diluted and ready-to-use fatty acid monoester formulation having a monoester concentration of between about 0.001 and 5.0 wt. % and, in some embodiments, between about 0.005 and 1.0 wt. %.

In embodiments of the present invention, one or more surfactants may be included in the liquid indicator composition of the leuco dye complex that is coated onto a substrate. The coating process and related formulation of the liquid composition are described elsewhere herein. In embodiments that incorporate a surfactant, it may not be necessary to include an adjuvant in addition to the surfactant. For example, the use of a chemical indicator test strip according to the present invention for the detection of certain fatty acid esters such as C₈ to C₁₂ fatty acid esters, (e.g., used in the antimicrobial treatment of foods) typically can be made without including an adjuvant to detect the ester in a ready-to-use formulation within the ester concentration ranges recited herein.

The present invention provides, in part, a method for the detection and quantification of fatty acid monoesters using the chemical indicator test strips described herein. Fatty acid monoesters detectable using the chemical indicator test strips of the invention include one or more fatty acid esters of a polyhydric alcohol, a fatty ether of a polyhydric alcohol, alkoxylated derivatives thereof (of either the ester or the ether), and combinations of two or more of the foregoing. Such compositions include an antimicrobial component that includes a fatty alcohol ester of a hydroxyacid, alkoxylated derivatives thereof, or combinations thereof. An effective amount of an antimicrobial component (typically, an antimicrobial lipid component) comprise a (C₇-C₁₄) saturated fatty alcohol monoester of a (C₂-C₈) hydroxycarboxylic acid, a (C₈-C₂₂) mono- or poly-unsaturated fatty alcohol monoester of a (C₂-C₈) hydroxycarboxylic acid, an alkoxylated derivative of either of the foregoing, or combinations thereof, wherein the alkoxylated derivative has less than 5 moles of alkoxide per mole of hydroxycarboxylic acid.

Suitable surfactants may be selected from any of the four primary groups; anionic, cationic, non-ionic, and zwitterionic (amphoteric). Exemplary surfactants suitable for use in the invention include those illustrated in the Examples herein.

Exemplary cationic surfactants include, but are not limited to, salts of optionally polyoxyalkylenated primary, secondary, or tertiary fatty amines; quaternary ammonium salts such as tetraalkylammonium, alkylamidoalkyltrialkylammonium, trialkylbenzylammonium, trialkylhydroxyalkylammonium, or alkylpyridinium having compatible anionic counterions such as halides (preferably chlorides or bromides) or alkyl sulfates such as methosulfate or ethosulfate as well as other anionic counterions; imidazoline derivatives; amine oxides of a cationic nature (e.g., at an acidic pH). In certain preferred embodiments, the surfactant(s) comprise one or more cationic surfactants selected from the group consisting of tetralkyl ammonium, trialkylbenzylammonium, and alkylpyridinium halides, and mixtures thereof.

In some embodiments, amine oxide surfactants may be used such as those including alkyl and alkylamidoalkyldialkylamine oxides. Examples of amine oxide surfactants include those commercially available from Stepan Company under the trade designations AMMONYX LO, AMMONYX LMDO, and AMMONYX CO, which are lauryldimethylamine oxide, laurylamidopropyldimethylamine oxide, and cetyl amine oxide.

In other embodiments, anionic surfactant(s) may be used including, but are not limited to, sarcosinates, glutamates, alkyl sulfates, sodium or potassium alkyleth sulfates, ammonium alkyleth sulfates, ammonium laureth-n-sulfates, laureth-n-sulfates, isethionates, alkyl and aralkyl glycerylether sulfonates, alkyl and aralkyl sulfosuccinates (e.g. dioctylsulfosuccinate), alkylglyceryl ether sulfonates, alkyl phosphates, aralkyl phosphates, alkylphosphonates, and aralkylphosphonates. These anionic surfactants may have a metal or organic ammonium counterion. In certain embodiments, the anionic surfactants useful in the compositions of the present invention are selected from the group consisting of sulfonates, sulfates, phosphates, phosphonates and combinations of two or more of the foregoing.

Suitable sulfonates and sulfates include alkyl sulfates, alkyl ether sulfates, alkyl sulfonates, alkylether sulfonates, alkylbenzene sufonates, alkylbenzene ether sulfates, alkylsulfoacetates, secondary alkane sulfonates, secondary alkylsulfates, and the like. Commercially available alkyl ether sulfonates such as lauryl ether sulfates are available under the trade designation POLYSTEP B12 and POLYSTEP B22 available from Stepan Company.

Other commercially available anionic surfactants include sodium methyl taurate (available under the trade designation NIKKOL CMT30 from Nikko Chemicals Co., Tokyo, Japan); secondary alkane sulfonates such as Hostapur SAS which is sodium (C₁₄-C₁₇) secondary alkane sulfonates (alpha-olefin sulfonates) available from Clariant Corp., Charlotte, N.C.; methyl-2-sulfoalkyl esters such as sodium methyl-2-sulfo(C12-16)ester and disodium 2-sulfo (C₁₂-C₁₆) fatty acid available from Stepan Company under the trade designation ALPHASTEP PC-48; alkylsulfoacetates and alkylsulfosuccinates available as sodium laurylsulfoacetate (under the trade designation LANTHANOL LAL) and disodiumlaurethsulfosuccinate (STEPANMILD SL3), both from Stepan Company; alkylsulfates such as ammonium lauryl sulfate commercially available under the trade designation STEPANOL AM from Stepan Company; dialkylsulfosuccinates such as dioctylsodiumsulfosuccinate available as AEROSOL OT from Cytec Industries.

Suitable phosphates and phosphonates include alkyl phosphates, alkylether phosphates, aralkylphosphates, and aralkylether phosphates. Such surfactants may include a mixture of mono-, di- and tri-(alkyltetraglycolether)-o-phosphoric acid esters generally referred to as trilaureth-4-phosphate commercially available under the trade designation HOSTAPHAT 340 KL from Clariant Corp., as well as PPG-5 ceteth 10 phosphate available under the trade designation CRODAPHOS SG from Croda Inc., Parsipanny, N.J., and mixtures thereof.

In still other embodiments, amphoteric surfactants may be used and include surfactants having tertiary amine groups, which may be protonated, as well as quaternary amine containing zwitterionic surfactants. Useful amphoteric surfactants include without limitation ammonium carboxylate amphoterics as well as ammonium sulfonate amphoterics. Examples of ammonium carboxylate amphoteric surfactants include, but are not limited to: certain betaines such as cocobetaine and cocamidopropyl betaine (commercially available under the trade designations MACKAM CB-35 and MACKAM L from McIntyre Group Ltd., University Park, Ill.); monoacetates such as sodium lauroamphoacetate; diacetates such as disodium lauroamphoacetate; amino- and alkylamino-propionates such as lauraminopropionic acid (commercially available under the trade designations MACKAM 1L, MACKAM 2L, and MACKAM 151L, respectively, from McIntyre Group Ltd.). Examples of ammonium sulfonate amphoterics, often referred to as “sultaines” or “sulfobetaines,” include cocamidopropylhydroxysultaine (commercially available as MACKAM 50-SB from McIntyre Group Ltd.). The sulfoamphoterics may be preferred over the carboxylate amphoterics since the sulfonate group will remain ionized at much lower pH values.

In yet other embodiments, nonionic surfactants may be used which include, but are not limited to, alkyl glucosides, alkyl polyglucosides, polyhydroxy fatty acid amides, sucrose esters, esters of fatty acids and polyhydric alcohols, fatty acid alkanolamides, ethoxylated fatty acids, ethoxylated aliphatic acids, ethoxylated fatty alcohols (e.g., octyl phenoxy polyethoxyethanol available under the trade name TRITON X-100 and nonyl phenoxy poly(ethyleneoxy) ethanol available under the trade name NONIDET P-40, both from Sigma, St. Louis, Mo.), ethoxylated and/or propoxylated aliphatic alcohols (e.g., that available under the trade name BRIJ from ICI), ethoxylated glycerides, ethoxylated/propoxylated block copolymers such as the PLURONIC and TETRONIC surfactants available from BASF, ethoxylated cyclic ether adducts, ethoxylated amide and imidazoline adducts, ethoxylated amine adducts, ethoxylated mercaptan adducts, ethoxylated condensates with alkyl phenols, ethoxylated nitrogen-based hydrophobes, ethoxylated polyoxypropylenes, polymeric silicones, fluorinated surfactants (e.g., those available under the trade names FLUORAD-FS 300 from 3M Company, St. Paul, Minn., and ZONYL from Dupont de Nemours Co., Wilmington, Del.), and polymerizable (reactive) surfactants (e.g., SAM 211 (alkylene polyalkoxy sulfate) surfactant available under the trade name MAZON from PPG Industries, Inc., Pittsburgh, Pa.). In certain embodiments, the nonionic surfactants useful in the compositions of the present invention are selected from the group consisting of Poloxamers such as PLURONIC from BASF, sorbitan fatty acid esters, and mixtures thereof.

It will be understood that the foregoing surfactants can be used individually or in combination of two or more of the foregoing.

### Substrates

As mentioned, the foregoing dye complex is coated onto a substrate to provide an indicator test strip according to the invention.

Any of a variety of materials may be used as a substrate or substrate material to which the dye complex is applied. In some embodiments, the substrate material can include cellulosic and non-cellulosic materials such as, for example, paper, natural or synthetic fibers, threads and yarns made from materials such as cotton, rayon, hemp, jute, bamboo fibers, cellulose acetate, carboxymethylated solvent-spun cellulose fibers and the like.

In some embodiments, the substrate may comprise material selected from polyester, polyamide, polyacrylamide, polyacetate, polyacrylics, polyolefin (e.g., polypropylene polyethylene, ethylene propylene copolymers, and ethylene butylene copolymers), polyurethane (including polyurethane foams), vinyl (e.g., polyvinylchloride), polystyrene, fiberglass, ceramic fiber, glass, silicon dioxide, polyacrylate, polyacrylonitrile, polyvinylidene difluoride, polytetrafluoroethylene, polyoxymethylene, polyvinyl alcohol, polylactic acid, polyvinyl ether, polyvinylpyrrolidone, polycarbonate, styrene-ethylenebutylene-styrene elastomer, styrene-butylene-styrene elastomer, styrene-isoprene-styrene elastomer, and combinations of two or more of the foregoing.

In certain embodiments, combinations of materials may be included within a substrate, and combinations of two or more of any of the foregoing materials is within the scope of acceptable substrates for use in the chemical indicator test strips of the present invention.

In various embodiments, the substrate can be porous or nonporous, and the dye complex can be coated onto a surface of the substrate or impregnated into it, for example. In embodiments of the invention, the substrate may be flexible and can comprise woven or nonwoven materials made of natural or synthetic compounds. In some embodiments, the substrate may be a polymeric web (non-woven or woven), a polymer film, a hydrocolloid, a foam material, a metallic foil, paper, and/or combinations of two or more of the foregoing. In some embodiments, the substrate can be an absorbent cotton gauze or a cotton swab, for example. In still other embodiments, the substrate is glass, such as a glass slide, for example.

Suitable porous materials for use as substrates in embodiments of the invention include paper, knits, wovens (e.g., cheese cloth and gauze), nonwovens (including spun-bonded nonwovens, and BMF (blown micro fibers), extruded porous sheets, and perforated sheets.

### Preparation of Chemical Indicator Test Strips

In preparing the chemical indicator test strips of the invention, a liquid indicator composition is applied to a suitable substrate and dried. In embodiments of the invention, the preparation of a chemical indicator test strip includes preparing a coatable liquid indicator composition that can be applied to the substrate. In general, the liquid indicator composition is prepared by adding at least one leuco dye and at least one developing agent to a solvent. Additional components for the indicator composition include the aforementioned adjuvant and/or the surfactant.

The components of the coatable liquid indicator composition may be added to the solvent in any order and mixed to ensure dissolution of the components in the solvent.

In some embodiments, the liquid indicator composition comprises a leuco dye and, optionally, an adjuvant in a suitable solvent such as, for example, MIBK or methyl isobutyl ketone. The concentrations of the individual components can vary within the scope of the invention. In some embodiments, the concentration of leuco dye is within the range between about 0.02% and about 2.0% by weight. In other embodiments, the leuco dye is within the range between about 0.05% and about 1.0% by weight. In still other embodiments, the concentration of leuco dye is within the range between about 0.1% and about 0.3% by weight.

As mentioned, the liquid indicator composition comprises developing agent. In some embodiments, the concentration of developing agent is within the range between about 0.2% and about 20% by weight. In other embodiments, the developing agent is within the range between about 0.5% and about 10% by weight. In still other embodiments, the concentration of developing agent is within the range between about 1% and about 3% by weight.

In the foregoing embodiments, the weight ratio between the leuco dye and the developing agent can range from about 10/1 to about 1/100. In some embodiments, the weight ratio between the leuco dye and the developing agent can range from about 5/1 to about 1/20. In still other embodiments, the weight ratio between the leuco dye and the developing agent can range from about 1/1 to about 1/10.

In embodiments where the liquid indicator composition comprises adjuvant, the concentration of adjuvant is within the range between about 0.2% and about 20% by weight. In other embodiments, the adjuvant is within the range between about 0.5% and about 10% by weight. In still other embodiments, the concentration of adjuvant is within the range between about 1% and about 3% by weight. In these embodiments, the weight ratio between the leuco dye and the adjuvant can range from about 10/1 to about 1/100. In some embodiments, the weight ratio between the leuco dye and the adjuvant can range from about 5/1 to about 1/20. In still other embodiments, the weight ratio between the leuco dye and the adjuvant can range from about 1/1 to about 1/10.

In embodiments where the liquid indicator composition comprises surfactant, the concentration of surfactant is within the range between about 0.04% and about 4% by weight. In other embodiments, the surfactant is within the range between about 0.08% and about 2% by weight. In still other embodiments, the concentration of surfactant is within the range between about 0.2% and about 0.6% by weight. In these embodiments, the weight ratio between the leuco dye and the surfactant can range from about 5/1 to about 1/5. In some embodiments, the weight ratio between the leuco dye and the surfactant can range from about 3/1 to about 1/3. In still other embodiments, the weight ratio between the leuco dye and the surfactant can range from about 2/1 to about 1/2.

In some embodiments, the process for preparing a chemical indicator will include the selection of the substrate. In some embodiments, the available surface area and absorptive characteristics of a material can be a factor in selecting a suitable substrate. For example, a porous material may provide a substrate with more surface area on which to coat the indicator composition. The surface area and absorptive characteristics of the substrate will also be a factor in how readily the organic analyte may be introduced for solvation with the dried leuco dye complex. In some embodiments, a non-absorbent material may be preferred over an absorbent material because the dried leuco dye is more readily maintained on the outermost surface of the non-absorbent substrate. In such a construction, the dried dye complex may be more readily available to form hydrogen bonds with an organic analyte when the chemical indicator test strip of the invention is used for monitoring a particular aqueous environment. In such embodiments, a non-absorbent material with at least some degree of porosity may be advantageously used as substrate in order to increase the total surface area of the substrate that is available to be coated with a leuco dye complex.

The process of applying the liquid indicator composition to the substrate requires the deposition of a sufficient quantity or volume of the liquid indicator composition to wet at least one surface of the substrate. A suitable amount or volume of the liquid indicator composition includes any amount or volume which, when dried, provides a dye-covered surface. Typically, the dye covered surface will be of sufficient area to allow for the representative sampling of an aqueous system or the like. Additionally, the surface area of the coated substrate will desirably be large enough an area so that color changes thereon will be readily detectable by an electronic detector, such as a densitometer or the like. In some embodiments, a light or thin coating of indicator composition may be preferred in order to provide a finished article with a dye complex closely associated with the outer surface of the substrate. The actual wet coating weights of the liquid indicator composition that is applied to the substrate can vary depending on the dye indicator and other components that are selected for inclusion in the finished article, the material chosen for a substrate, the coatable surface area of the selected substrate, and the like. The determination of an appropriate coating weight for the indicator composition on a substrate is within the skill of those practicing in the field without undue experimentation.

Once dried, the liquid indicator composition forms a colored coating on the substrate and the resulting article may be used as a chemical indicator test strip according to the present invention. Drying may be accomplished by any suitable means. In some embodiments, drying is accomplished by placing the wetted substrate in an oven or the like at an elevated temperature for sufficient time to drive off solvent and to provide a dried article suitable for use as described herein. In some embodiments, the wetted substrate is dried at ambient or room temperature by simply allowing the solvent to evaporate. In other embodiments, the wetted substrate may be placed in an oven for a short time (e.g., several minutes) at an elevated temperature (e.g., 150° F. or 66° C.). Once dried, the resulting article is available for use as a chemical indicator test strip.

Those skilled in the art will appreciate that methods for the manufacture of the chemical indicator test strips of the invention are further illustrated in the various Examples herein.

### Use of Chemical Indicator Test Strips

The chemical indicator test strips of the invention provide a non-specific analytical tool to detect the presence of organic analytes in a solvent (e.g., water). In processes or systems where the analyte is already known, the chemical indicator test strips of the invention provide a convenient and rapid means for monitoring an organic analyte, qualitatively and/or quantitatively. The chemical indicator test strips of the invention may be used in monitoring any of a variety of processes to detect and/or measure the amount of any of a variety of organic analytes in an aqueous formulation, process stream, bath or the like.

In embodiments where the chemical indicator test strip is used solely for qualitative monitoring for the presence or absence of an analyte, the chemical indicator test strip is simply immersed into the process stream or other liquid in which the analyte may be present. The indicator test strips may be immersed within the liquid sample and mildly agitated for a sufficient amount of time to adequately wet the strip (e.g., 10-20 seconds). Upon removal of the test strip from the liquid, it may be blotted with a paper towel or the like using gentle pressure to remove excess liquid. In some embodiments, the presence of an analyte may be detected visually by observing a color change to the test strip, typically by observing a lightening in the color of the dye complex on the substrate. If needed, the test strip may be compared to a ‘control’ strip having the initial or starting color of the dye complex prior to immersion and exposure to an organic analyte.

In some embodiments, the qualitative determination of the presence of an organic analyte is more readily apparent by electronically comparing the color of the test strip before and after its immersion in a testing environment to determine whether a color change has occurred. A densitometer, for example, may be useful in the determination of a color change by measuring the optical density of the exposed test strip relative to an unexposed test strip.

In some embodiments, the chemical indicator test strips of the invention are used qualitatively in determining the presence of an organic analyte as well as being used quantitatively to determine the concentration of the organic analyte. In embodiments that provide quantitative results, a standardization curve is prepared to provide a standard relationship between optical density and analyte concentration. Such a standardization curve may be based on a prepared set of standard solutions that resemble the expected chemical make-up of the stream, bath or compositions that are to be monitored. Standard analyte solutions typically will be made to cover the range of analyte concentrations that might reasonably be expected for the process that is being monitored. Using the aforementioned standards, a standardization plot of optical density v. analyte concentration may then be established. Thereafter, optical density readings on samples obtained in a monitoring process can be compared against the standardization plot to determine a concentration of analyte in a sample based on a measurement of the optical density for a chemical indicator test strip.

In the quantitative determination of an organic analyte, the standard compositions used to determine the standard curve are preferably similar to or substantially chemically the same as the compositions of the expected samples. In using chemical indicator test strips for such a quantitative determination, the amount of time that any of the test strips are exposed to an analyte process stream or the like ought to be substantially the same from one sample to the next and the same for the samples as for the standard solutions.

In embodiments of the invention, the chemical indicator test strips of the invention are capable of detecting organic analytes in a composition, process stream or the like at analyte concentrations in the range from about 0% to about 50% by weight. In some embodiments, the detection limits for certain organic analytes ranges from about 0% to about 25% by weight.

### Examples

Further aspects of the use of the chemical indicator test strips of the invention may be apparent to those skilled in the art upon consideration of the various non-limiting Examples herein.

### Example 1

### Construction of an Indicator Strip with a Substantially Water-Insoluble Quinoid Dye Complex

Twenty milligrams of Pergascript Blue I-2RN obtained from Ciba-Geigy Specialty Chemicals, NC was dissolved in 5 grams of methyl isobutyl ketone (MIBK) obtained from Aldrich Chemicals. Separately, 200 milligrams of poly(4-vinyl phenol), M.W.=8000 Da as developing agent and 20 milligrams sodium dioctylsulfosuccinate surfactant (both obtained from Aldrich Chemicals) were dissolved in 5 grams MIBK. The two solutions were mixed together to obtain a clear homogenous solution. Blank indicator strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned deep blue on evaporation of the MIBK. The chemical indicator test strip was dried at 150° F. for 1 minute, and cooled.

### Comparative Example 1

### Construction of an Indicator Strip from a Dye Complex with a Water Soluble Developing Agent—Bisphenol-A)

Twenty milligrams of Pergascript Blue I-2RN (6-(Dimethylamino)-3,3-bis [4-(dimethylamino)phenyl]phthalide) obtained from Ciba-Geigy Specialty Chemicals, NC was dissolved in 5 grams of methyl isobutyl ketone (MIBK) obtained from Aldrich Chemicals. Separately, 200 milligrams of bisphenol-A and 20 milligrams sodium dioctyl sulfosuccinate surfactant (both obtained from Aldrich Chemicals) were dissolved in 5 grams MIBK. The two solutions were mixed together to obtain a clear homogenous solution. Blank chemical indicator test strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned deep blue on evaporation of the MIBK. The indicator strip was dried at 150° F. for 1 minute, and cooled.

### Example 2

### Use of the Indicator in Example 1

Aqueous solutions of n-propanol (obtained from Aldrich Chemicals) were prepared in a range of concentrations from 0% w/w to 14% w/w. Chemical indicator test strips of the type described in Example 1 were prepared and immersed with mild agitation in these solutions for 15 seconds each. Each strip was then removed from solution, quickly blotted using gentle pressure on an absorbent paper towel, and the optical density immediately measured on a MacBeth RD917 densitometer using the green filter setting. A gradual decrease in color intensity could be visually distinguished with an increase in propanol concentration.

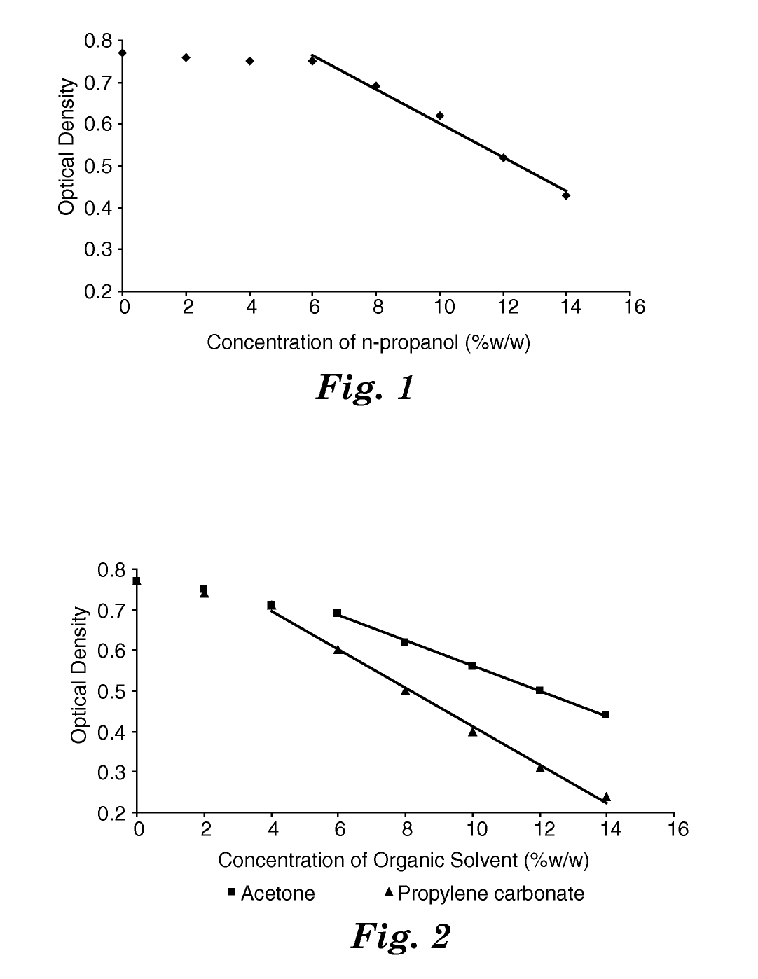

The results are graphically represented in FIG. 1 illustrating that the optical density of the indicator is linearly related to the aqueous concentration of indicator above a concentration of about 6%.

### Example 3

### Use of the Indicator in Example 1 for Low Vapor Pressure and High Vapor Pressure Solvents

Aqueous solutions of acetone and propylene carbonate (both obtained from Aldrich Chemicals) were prepared in a range of concentrations from 0% w/w/ to 14% w/w. Chemical indicator test strips of the type described in Example 1 were prepared and immersed with mild agitation in these solutions for 15 seconds each. Each strip was then removed from solution, quickly blotted using gentle pressure on an absorbent paper towel, and the optical density immediately measured on a MacBeth RD917 densitometer using the green filter setting. A gradual decrease in color intensity could be visually distinguished with an increase in solvent concentration.

The results are graphically represented in FIG. 2, showing that even though propylene carbonate has a much lower vapor pressure (0.03 mm Hg at 20° C.) than acetone (185 mm Hg at 20° C.), it exhibits a higher change in optical density per unit concentration change. The linear region of optical density vs. concentration extends down to 4% compared with a 6% lower limit for acetone.

### Example 4

### Construction and Use of an Indicator with a Different Lactone Dye

Twenty milligrams of Pergascript Red I-6B (3,3-bis(2-methyl-l-octyl-1h-indol -3-yl)phthalide) obtained from Ciba-Geigy Specialty Chemicals, NC was dissolved in 2.5 grams of MIBK. Separately, 200 milligrams of poly(4-vinyl phenol), M.W.=8000 Da and 20milligrams sodium dioctylsulfosuccinate were dissolved in 2.5 grams MIBK. The two solutions were mixed together to obtain a clear homogenous solution. Blank indicator strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned deep red on evaporation of the MIBK. The indicator strip was dried at 150° F. for 1 minute, and cooled prior to use.

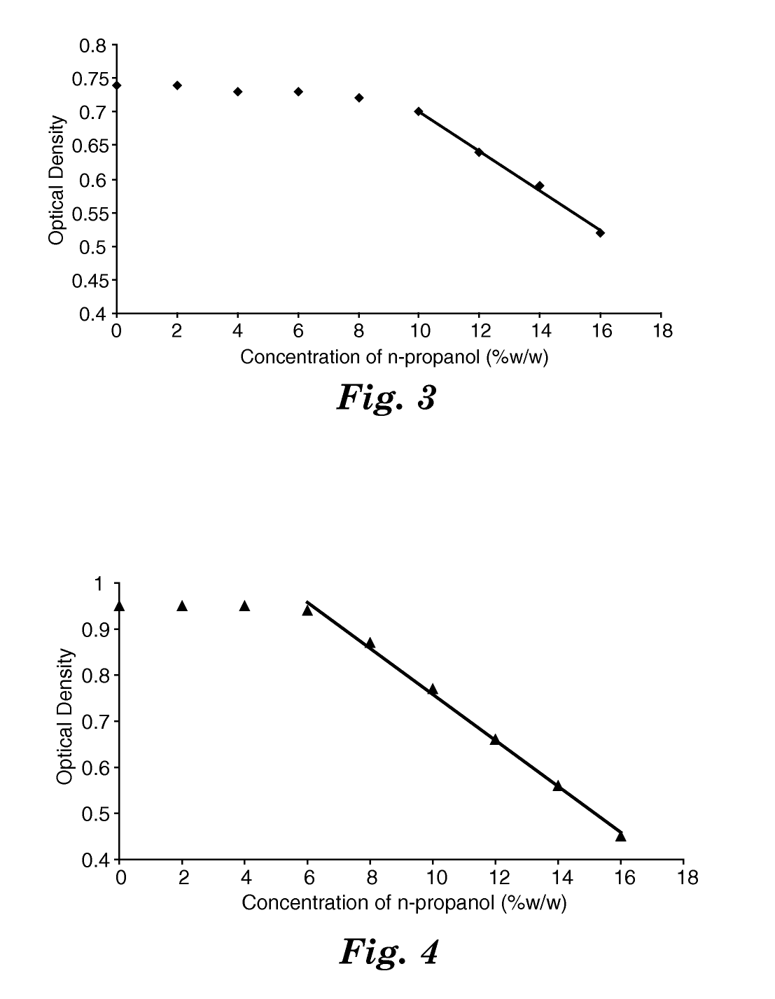

Aqueous solutions of n-propanol were prepared in a range of concentrations from 0% w/w/ to 16% w/w. Chemical indicator test strips of the type described above were prepared and immersed with mild agitation in these solutions for 15 seconds each. Each strip was then removed from solution, quickly blotted using gentle pressure on an absorbent paper towel, and the optical density immediately measured on a MacBeth RD917 densitometer. A gradual decrease in color intensity could be visually distinguished with an increase in solvent concentration. The results are graphically represented in FIG. 3 below. As with the chemical indicator test strip comprising a blue dye (see FIG. 1), the chemical indicator test strip made with red dye also displayed a linear region of optical density change with concentration. However, the blue indicator has shown a lower linear detection limit (6%) compared with the red indicator (10%).

### Example 5

### Construction and Use of an Indicator with 4,4′-(9-Fluorenylidene)-Diphenol as Hydrophobic Developing Agent

Twenty milligrams of the leuco dye Pergascript Blue I-2RN (Ciba-Geigy Specialty Chemicals, NC) was dissolved in 5 grams of MIBK. Separately, 200 milligrams of developing agent 4,4′-(9-fluorenylidene)-diphenol (obtained from Aldrich Chemicals) and 20 milligrams of sodium dioctylsulfosuccinate were dissolved in 5 grams MIBK. The two solutions were mixed together to obtain a clear homogenous solution. Blank indicator strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned deep blue on evaporation of the MIBK. The chemical indicator test strip was dried at 150° F. for 1 minute, and cooled prior to use.

Aqueous solutions of n-propanol were prepared in a range of concentrations from 0% w/w/ to 16% w/w. Chemical indicator test strips of the type described above were immersed with mild agitation in the n-propanol solutions for 15 seconds each. Each strip was then removed from solution, quickly blotted using gentle pressure on an absorbent paper towel, and the optical density immediately measured on a MacBeth RD917 densitometer. A gradual decrease in color intensity could be visually distinguished with an increase in solvent concentration. The results are graphically represented in FIG. 4 which displays a linear region of optical density changing with concentration.

### Example 6

### Comparison of Water Stability of the Indicators from Example 1, Comparative Example 1, and Example 5

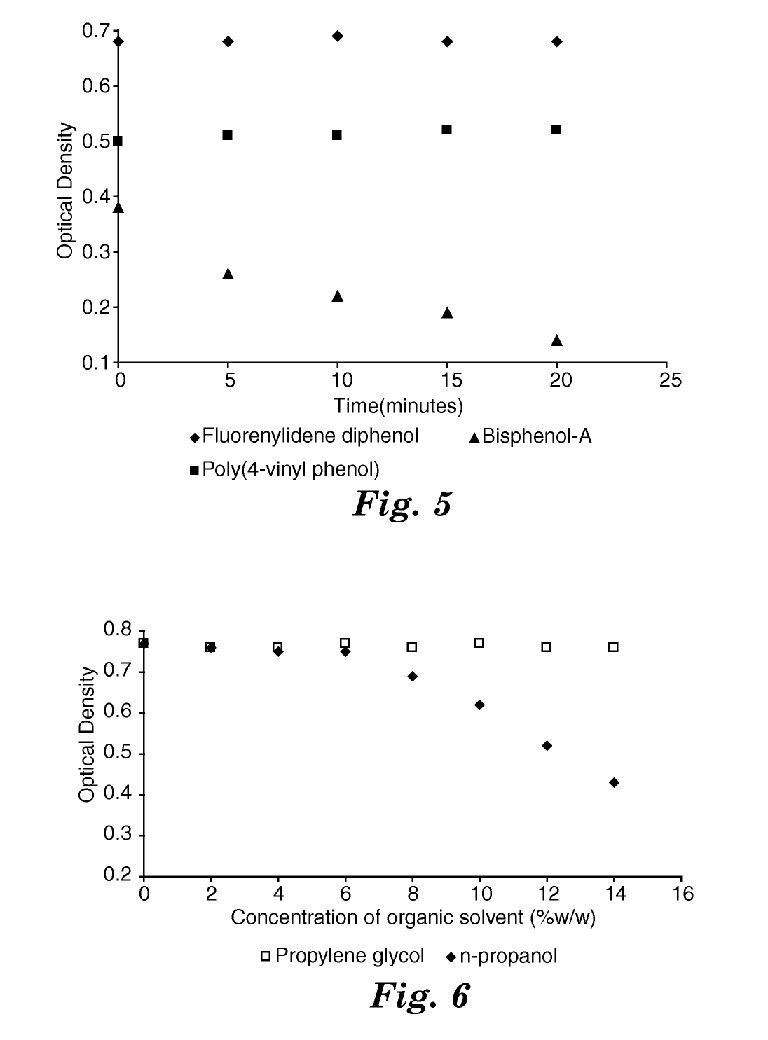

The chemical indicator test strips constructed as described in Example 1,Comparative Example 1 and Example 5 were immersed in an aqueous solution of 12% n-propanol for different lengths of time ranging from 15 seconds to 20 minutes. Each strip was then removed from solution, quickly blotted using gentle pressure on an absorbent paper towel, and the optical density immediately measured on a MacBeth RD917 densitometer. The results are shown graphically in FIG. 5, showing that chemical indicator test strips prepared with substantially water-insoluble developing agents show extremely good solution stability, while the leuco dye complex in the chemical indicator test strip constructed using bisphenol A, a hydrophilic developing agent, quickly degrades in water. Additionally, the chemical indicator test strip using bisphenol-A as a developing agent went from a blue color to becoming almost colorless on immersion, while the other chemical indicator test strips retained their color.

### Example 7

Aqueous solutions of n-propanol and propylene glycol (obtained from Aldrich Chemicals) were prepared in a range of concentrations from 0% w/w/ to 16% w/w. Chemical indicator test strips of the type described in Example 1 were prepared and immersed in these solutions for 15 seconds each under mild agitation. Each strip was then removed from solution, quickly blotted using gentle pressure on an absorbent paper towel, and the optical density immediately measured on a MacBeth RD917 densitometer. A gradual decrease in color intensity could be visually distinguished with an increase in solvent concentration for the propanol solutions. No change in optical density was observed even at the highest concentration of propylene glycol employed. The difference in reactivities of these two closely related alcohols lies is attributed to n-propanol being capable of solvating poly(4-vinyl phenol) while propylene glycol is not. The results are graphically represented in FIG. 6, indicating that chemical indicator test strips according to the present invention can selectively show a color change with one of two closely related organic solvents based on the differences in their ability to solvate the developing agent employed.

### Example 8

### Construction of an Indicator Strip with a Substantially Water-Insoluble Leuco Dye Complex and a Water-Insoluble Adjuvant

Twenty milligrams of leuco dye Pergascript Blue I-2RN obtained from Ciba-Geigy Specialty Chemicals, NC was dissolved in 2.5 grams of methyl isobutyl ketone (MIBK) obtained from Aldrich Chemicals. Separately, 200 milligrams of developing agent poly(4-vinyl phenol), M.W.=8000 Da (obtained from Aldrich Chemicals)and 200 milligrams of adjuvant acetyltributyl citrate (Citroflex A-4 by Moreflex Inc., NC) were dissolved in 5 grams MIBK. The two solutions were mixed together to obtain a clear homogenous solution. Blank chemical indicator test strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned deep blue on evaporation of the MIBK. The chemical indicator test strip was dried at 150° F. for 1 minute, and cooled.

### Comparative Example 2

This example demonstrates the construction of an indicator strip with a substantially water-insoluble quinoid dye complex and a water-insoluble non-polar aprotic compound. Twenty milligrams of Pergascript Blue I-2RN was dissolved in 2.5 grams of methyl isobutyl ketone (MIBK). Separately, 200 milligrams of poly(4-vinyl phenol), Mol. Wt.=8000 Da, and 400 milligrams mineral oil (obtained from Cumberland Swan, TN) were dissolved in 2.5 grams MIBK. The two solutions were mixed together to obtain a clear homogenous solution. Blank indicator strips were prepared by heat bonding a 0.3″ by 0.3″ swatch of Whatman 114 filter paper to one end of a 4″ by 0.3″ polyester strip (5 mils thick) using a supported double-sided PSA. Five microliters of the solution were spotted on the paper. The initially colorless spot turned deep blue on evaporation of the MIBK. The indicator strip was dried at 150° F. for 1minute, and cooled.

### Example 9

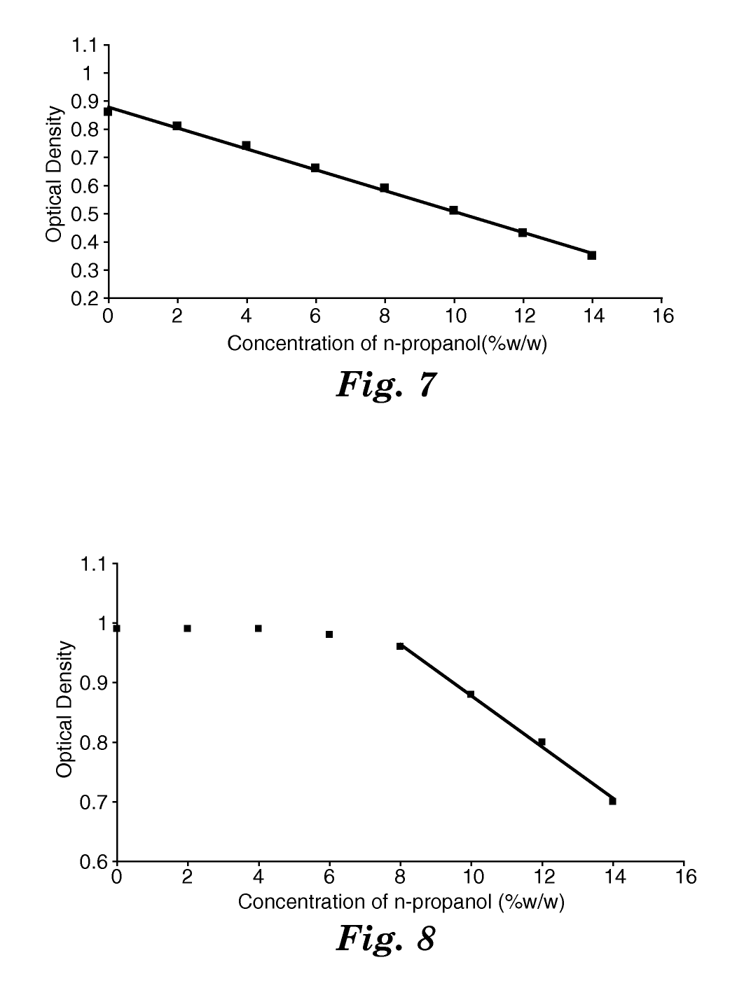

This example demonstrates the use of the chemical indicator test strip of Example 8. Aqueous solutions of n-propanol (obtained from Aldrich Chemicals) were prepared in a range of concentrations from 0% w/w/ to 14% w/w. Chemical indicator test strips of the type described in Example 8 were prepared and immersed with mild agitation in these solutions for 15 seconds each. Each strip was then removed from solution, quickly blotted using gentle pressure on an absorbent paper towel, and the optical density immediately measured on a MacBeth RD917 densitometer using the green filter setting. A gradual decrease in color intensity could be visually distinguished with an increase in propanol concentration. The results are graphically represented in FIG. 7 showing a linear dependence of the optical density on concentration in the entire analyte concentration range.

Chemical indicator test strips of the type described above were prepared but with no adjuvant. The strips were immersed with mild agitation in the n-propanol solutions for 15 seconds each. Each strip was then removed from solution, quickly blotted using gentle pressure on an absorbent paper towel, and the optical density immediately measured on a MacBeth RD917 densitometer using the green filter setting. A gradual decrease in color intensity could be visually distinguished with an increase in propanol concentration above a certain value. The results are graphically represented in FIG. 8 with the linear region of the curve extending down to 8% n-propanol.

### Example 10

### Construction and Use of a Chemical Indicator Test Strip with a Different Hydrophobic Polar Aprotic Chemical

Twenty milligrams of leuco dye Pergascript Blue I-2RN was dissolved in 2.5 grams of MIBK. Separately, 200 milligrams of developing agent poly(4-vinyl phenol), M.W.=8000 Da and 400 milligrams adjuvant N-butylbenzenesulfonamide (Aldrich Chemicals) were dissolved in 2.5 grams MIBK. The two solutions were mixed together to obtain a clear homogenous solution. Blank chemical indicator test strips were prepared by heat bonding a 0.3″ by 0.3″ swatch of Whatman 114 filter paper (obtained from Whatman International, England) to one end of a 4″ by 0.3″ polyester strip (5 mils thick) using a supported double-sided PSA. Five microliters of the solution were spotted on the paper. The initially colorless spot turned blue on evaporation of the MIBK. The indicator strip was dried at 150° F. for 1 minute, and cooled.

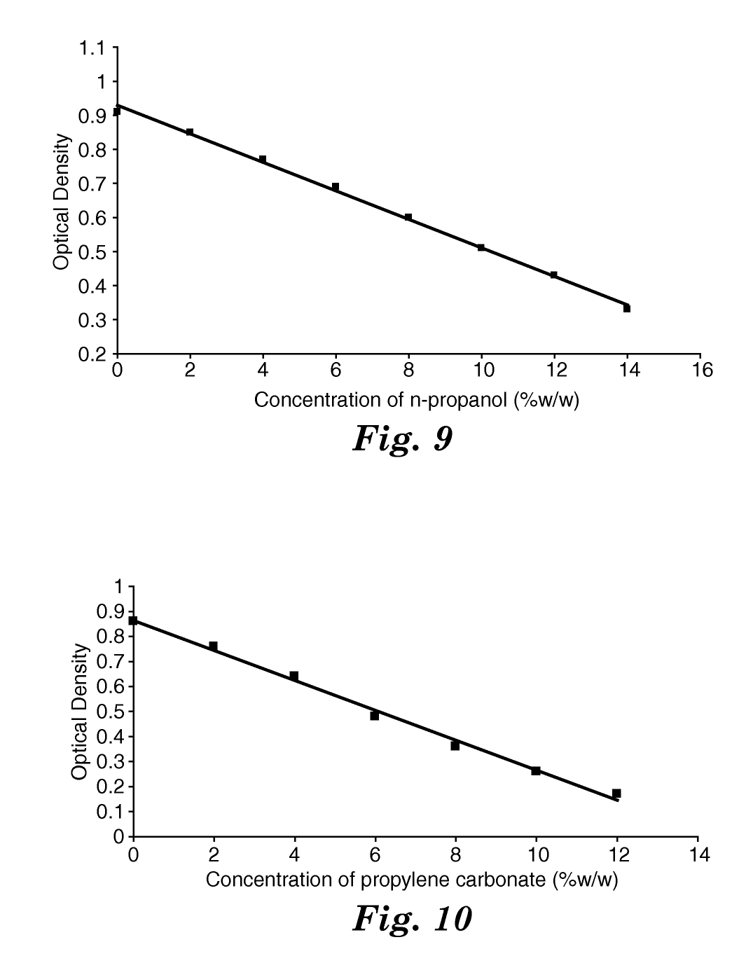

Aqueous solutions of n-propanol were prepared in a range of concentrations from 0% w/w/ to 16% w/w. Chemical indicator test strips of the type described above were prepared and immersed with mild agitation in these solutions for 15 seconds each. Each strip was then removed from solution, blotted using gentle pressure on an absorbent paper towel, and the optical density immediately measured on a MacBeth RD917 densitometer. A gradual decrease in color intensity could be visually distinguished with an increase in solvent concentration. Results are shown in FIG. 9.

### Example 11

### Use of the Indicator in Example 8 with a Propylene Carbonate Analyte

Aqueous solutions of propylene carbonate (Aldrich Chemicals) were prepared in a range of concentrations from 0% w/w/ to 12% w/w. Chemical indicator test strips of the type described in Example 8 were prepared and immersed with mild agitation in the propylene carbonate solutions for 15 seconds each. Each strip was removed from solution, quickly blotted using gentle pressure on an absorbent paper towel, and the optical density immediately measured on a MacBeth RD917 densitometer using the green filter setting. A gradual decrease in color intensity could be visually distinguished with an increase in propylene carbonate concentration. The results are graphically represented in FIG. 10 where the linear dependence of optical density on concentration extends down to near 0% analyte in water.

### Example 12

Twenty milligrams of Pergascript Blue I-2RN (Ciba-Geigy Specialty Chemicals, NC) was dissolved in 5 grams of MIBK (Aldrich Chemicals). Separately, 200 milligrams of 4,4′-(9-fluorenylidene)-diphenol and 40 milligrams sodium dioctylsulfosuccinate (Aldrich Chemicals) were dissolved in 5 grams MIBK. The two solutions were mixed together to obtain a single clear homogenous solution. Blank chemical indicator test strips were prepared from blotting paper #703 obtained from VWR Scientific, PA. Five microliters of the solution were spotted on the paper. The initially colorless spot turned deep blue on evaporation of the MIBK. The chemical indicator test strip was dried at 150° F. for 10 minutes and cooled.

### Example 13

### Detection of Fatty Acid Monoester

Aqueous acid solutions of a mixture of propylene glycol monocaprylate (Abitec, 99% purity, FCC grade) and dioctylsulfosuccinate (Cytec, FCC grade) in the weight ratio 98:2 were prepared in a range of concentrations from 0% w/w/ to 1% w/w and used as analyte solutions. The solution was 0.25% in lactic acid and 0.25% in malic acid (Brenntag, FCC grade).

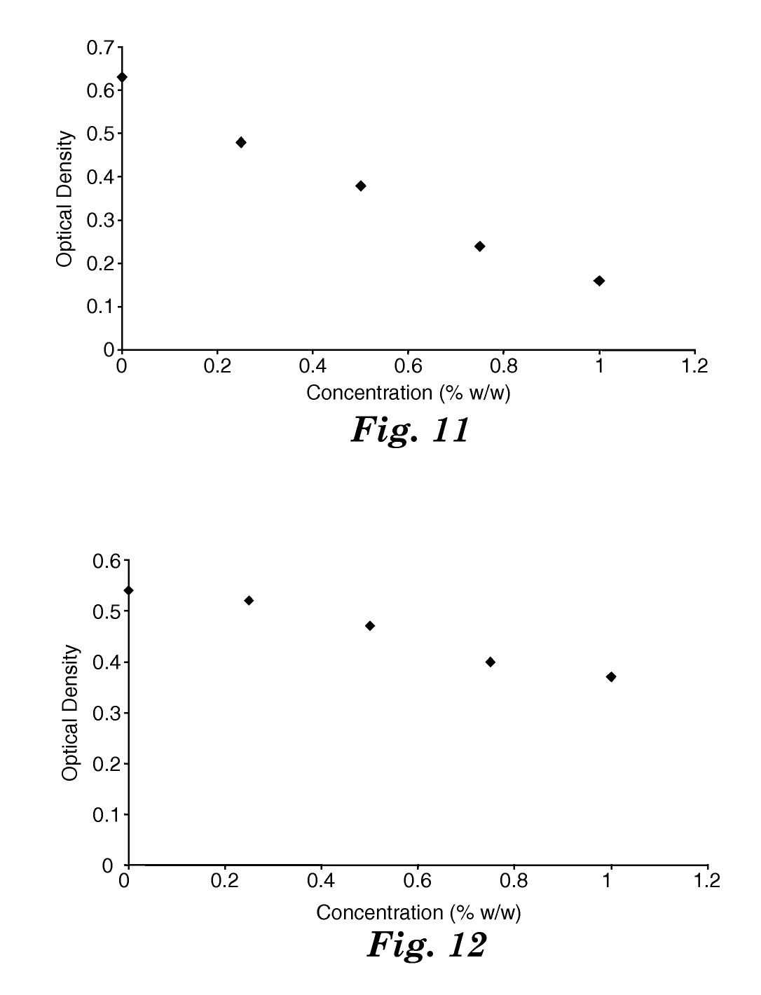

Chemical indicator test strips of the type described in Example 12 were prepared and spotted with 40 microliters of the analyte solutions over the indicator area. Each strip was then developed at room temperature for ten minutes and dried at 150° F. for five minutes. The optical density of the chemical indicator test strips was measured on a MacBeth RD917 densitometer using the red filter setting under null density conditions. A gradual decrease in color intensity could be visually distinguished with an increase in ester concentration. The results are graphically represented in FIG. 11 showing that the optical density of the chemical indicator test strip is linearly dependent on the aqueous concentration of the monoester with a large response per unit concentration change.

### Example 14

Twenty milligrams of leuco dye Pergascript Blue I-2RN (Ciba-Geigy Specialty Chemicals, NC) was dissolved in 5 grams of MIBK (Aldrich Chemicals). Separately, 200milligrams of developing agent poly(4-vinyl phenol), M.W.=8000 Da and 40 milligrams sodium dioctylsulfosuccinate (both obtained from Aldrich Chemicals)were dissolved in 5 grams MIBK. The two solutions were mixed together to obtain a clear homogenous solution. Blank chemical indicator test strips were prepared from blotting paper #703 obtained from VWR Scientific, PA. Five microliters of the solution were spotted on the paper. The initially colorless spot turned deep blue on evaporation of the MIBK. The indicator strip was dried at 150° F. for 10 minutes, and cooled.

### Example 15

Aqueous acid solutions of a mixture of propylene glycol monocaprylate (Abitec, 99% purity, FCC grade) and dioctylsulfosuccinate (Cytec, FCC grade) in the weight ratio 98:2 were prepared in a range of concentrations from 0% w/w/ to 1% w/w. The solution was 0.25% in lactic acid and 0.25% in malic acid (Brenntag, FCC grade). Chemical indicator test strips of the type described in Example 13 were prepared and spotted with 40 microliters of the test solution over the indicator area. Each strip was then developed at room temperature for ten minutes and dried at 150° F. for five minutes. The optical density of the strips was measured on a MacBeth RD917 densitometer using the red filter setting under null density conditions. A very gradual decrease in color intensity could be visually distinguished with an increase in ester concentration. The results are graphically represented in FIG. 12.

Although features of the invention have been described in the context of the various embodiments set forth herein, those skilled in the art will appreciate that changes and modifications may be made to the described embodiments without departing from the spirit and scope of the invention.

What is claimed is:

1. A method of using a chemical indicator test strip, comprising:
(a) Exposing a chemical indicator test strip to a liquid sample comprising an organic analyte in solution, the chemical indicator test strip, comprising:
A substrate; and
A coating comprising a leuco dye complex on the substrate, the coating being insoluble in water and reactive with an organic analyte, the coating derived from a solution of leuco dye and developing agent;
(b) Measuring a color change on the chemical indicator test strip following the exposing step;
(c) Correlating the color change with the concentration of the analyte in the sample.

2. The method of claim 1, further comprising reporting the concentration of the analyte.

3. The method of claim 1 further comprising establishing a standard relationship between color change on the chemical indicator test strip and the concentration of analyte in a sample.

4. The method of claim 1, wherein the leuco dye is selected from the group consisting of acyl auramines, acylleucophenothiazines, alpha-unsaturated aryl ketones, azaphthalides, benzoyl leuco methylene blue, benzoyl leuco oxyazine, benzoyl leuco thiazine, beta-unsaturated aryl ketones, basic mono azo dyes, bisindolylphthalide, 10-benzoyl-N,N,N,N-tetraethyl-3,7-diamino-10H-phenoxazine, carbazolyl blue, chromogenic azaphthalide compounds, crystal violet lactone, diaryl phthalides, diphenylmethanes, dithio-oxamide, di[bis-(indoyl)ethyleneyl]tetraholophthalides, fluoran, fluoran derivatives (e.g., 3-dialkylamino-7-dialkylamylfluoran), green lactone, 3-(indol-3-yl)-3-(4-substituted aminophenyl)phthalides, indolyl bis-(indoyl)ethylenes, indolyl red, leucoauramines, leucobenzoyl methylene blue, leuco malachite green, 3-methyl-2,2-spirobi(benzo-[f]-chromene), phenoxazine, phthalide leuco dyes, phthlans, polystyrl carbinols, 8-methoxybenzoindolinospiropyrans, rhodamine beta lactams, spiropyrans, substituted 4,7-diazaphthalides, para-toluene sulfonate of Michler's hydrol, triarylmethane, triphenylmethanes (gentian violet and malachite green), sultines, 3,3-diaryl-3H-2,1-benzoxathiole 1-oxides, and combinations of two or more of the foregoing.

5. The method of claim 1, wherein the developing agent comprises a proton donor.

6. The method of claim 1, wherein the developing agent comprises a weak acid selected from the group consisting of bisphenol A, octyl p-hydroxybenzoate, methyl p-hydroxybenzoate, 1,2,3-triazoles, 4-hydroxycoumarin derivatives, and combinations of two or more of the foregoing.

7. The method of claim 1, wherein the developing agent comprises one or more Lewis acids.

8. The method of claim 1, wherein the Lewis acids comprise activated clay substances selected from the group consisting of attapulgite, acid clay, bentonite, montmorillonite, acid-activated bentonite, montmorillonite, zeolite, hoalloysite, silicon dioxide, aluminum oxide, aluminum sulfate, aluminum phosphate, hydrated zirconium dioxide, zinc chloride, zinc nitrate, activated kaolin and combinations of two or more of the foregoing.

9. The method of claim 1, wherein the developing agent comprises an organic compound selected from the group consisting of ring-substituted phenols, resorcinols, salicylic acids (e.g., 3,5-bis(αα′-dimethylbenzyl)salicylic; 3,5-bis((γ-methylbenzyl)salicylic acid), or salicyl acid esters and metal salts thereof.

10. The method of claim 1, wherein the developing agent comprises one or more acidic organic compounds comprising polymeric materials selected from the group consisting of phenolic polymer, alkylphenolacetylene resin, maleic acid/colophonium resin, partially or fully hydrolyzed polymer of maleic anhydride with styrene, ethylene or vinyl methyl ether, carboxymethylene and mixtures of two or more of the foregoing.

11. The method of claim 1, wherein the developing agent comprises phenolic resins or phenolic compounds selected from the group consisting of 4-tert-butylphenol; 4-phenylphenol; methylene-bis(p-phenylphenol); 4-hydroxydiphenyl ether; alpha-naphthol; beta-napthol; methyl 4-hydroxybenzoate; benzyl 4-hydroxybenzoate; 4-hydroxydiphenyl sulfone; 4-hydroxyacetophenone; 2,2′-dihydroxydiphenyl; 4,4′-cyclohexylidenephenol; 4,4′-isopropylidenediphenol; 4,4-isopropylidenebis(2-methylphenol); a pyridine complexes of zinc thiocyanate; 4,4-bis(4-hydroxyphenyl)valeric acid; hydroquinone; pyrogallol; phoroglucine; p-hydroxybenzoic acid; m-hydroxybenzoic acid; o-hydroxybenzoic acid; gallic acid; 1-hydroxy-2-naphthoic acid.

12. The method of claim 1, wherein the coating further comprises adjuvant.

13. The method of claim 1, wherein the adjuvant is a water-insoluble, polar, hydrophobic, aprotic material that extends the lower limit of detection for the analyte than is otherwise attainable in the absence of such an adjuvant.

14. The method of claim 1, wherein the adjuvant comprises at least one aliphatic or aromatic ester of a carboxylic acid, the ester selected from the group consisting of citrates, phthalates, adipates, benzoates, azelates, mellitates and combinations of two or more of the foregoing.

15. The method of claim 1, wherein the adjuvant is selected from the group consisting of organic phosphates, organic sulfonates, sulfonamides and combinations of two or more of the foregoing.

16. The method of claim 1, wherein the adjuvant is selected from the group consisting of citrates and sulfonamides and combinations thereof.
